(19) United States
(12) Patent Application Publication
(10) Pub. No.: US 2010/0106480 A1
(43) Pub. Date: Apr. 29, 2010

(54) CHARACTER DATA PROCESSING METHOD, COMPUTER PROGRAM, AND CHARACTER DATA PROCESSING SYSTEM

(75) Inventors: Kunihiko Sadamasa, Tokyo (JP); Shinichi Doi, Tokyo (JP); Shinichi Ando, Tokyo (JP); Takashi Onishi, Tokyo (JP)

Correspondence Address: FOLEY AND LARDNER LLP;SUITE 500, 3000 K STREET NW, WASHINGTON, DC, 20007, US

(73) Assignee: NEC Corporation

(21) Appl. No.: 12/450,275

(22) PCT Filed: Mar. 12, 2008
(86) PCT No.: PCT/JP2008/055018

§ 371 Date: Sep. 18, 2009

(30) Foreign Application Priority Data
Mar. 27, 2007 (JP) 2007 081916

(51) Int. Cl. G06F 17/28

(52) U.S. Cl. 704/2; 704/E11.001

(57) ABSTRACT

When part or all of first character data is converted into another expression to generate second character data, there are prepared an acceptance rule indicative of correspondence between a language phenomenon, a principal word of the language phenomenon, and a scope of the language phenomenon, and a conversion method as correspondence between a language phenomenon and another expression into which an expression of the language phenomenon is converted. The acceptance rule stored in the storage device is applied for a word W included in the first character data, and an acceptance part of one of the word W, a phrase, a clause, and a sentence including the word W is extracted. A converted expression of the acceptance part is generated in accordance with the conversion method stored in the storage device that corresponds to a language phenomenon of the extracted acceptance part. The second character data are generated based on the converted expression and the first character data.

### TECHNICAL FIELD

The present invention relates to a machine translation system, a machine translation method, and a machine translation program, and more particularly to a machine translation system, a machine translation method, and a machine translation program for generating a first translation result by machine translation and then modifying the translation result in accordance with user's instructions to thereby generate a second translation result.

### BACKGROUND ART

Heretofore, machine translation systems for translation from a first language into a second language have been used to support manual translation work. However, machine translation systems do not necessarily have a sufficiently high accuracy of translation. Therefore, there have been proposed frameworks for allowing a user to readily adjust a translation of a machine translation system.

For example, there has been proposed a device that prepares a plurality of equivalent terms for each word and replaces a certain equivalent term in a translation result with another prepared equivalent term by a simple operation for thereby generating a translation result that is preferred by a user. One of examples of such a system is disclosed at “2.8 Translation Box Menu ‘Word Menu’ [Equivalent Term Selection]” of pages 45-46 of “Translation Adapter II CrossRoad Ver. 3.0 Handbook,” published in 1999. This document is hereinafter referred to as Non Patent Document 1.

The machine translation system disclosed in Non Patent Document 1 includes input means, translation means, word selection means, equivalent term selection means, equivalent term reflection means, and output means. The input means inputs a sentence in a first language. The translation means translates the inputted sentence into a second language. The word selection means allows a user to select a word for which a user wants to change the term in the translation result, as an acceptance part for selection of equivalent terms. The equivalent term selection means displays a list of possible equivalent terms for the selected word and allows the user to select another equivalent term. The equivalent term reflection means replaces the word selected by the word selection means with the equivalent term selected by the equivalent term selection means. The output means outputs the resultant new translation result.

According to the invention disclosed in Non Patent Document 1, selection is made in the level of words in a translation result. Therefore, there cannot be selected a translation method that can modify a translation in a wide range, e.g., in the level of phrases such as noun phrases, declinable phrases, adverbial phrases, and preposition phrases, in the level of clauses such as main clauses, subordinate clauses, and relative clauses, and in the level of the entire sentence.

In contrast to the above, there has been proposed a device that allows a user to preselect translation methods under various conditions before machine translation for thereby generating a translation result that is preferred by the user. Such a system cannot only select a word-level translation method in which only a translation of a target word is changed, such as selection of equivalent terms, but also select a translation method that can modify a translation in a wide range, e.g., in the level of phrases, clauses, or sentences. Hereinafter, the levels of phrases, clauses, and sentences are collectively referred to as a phrase level. Furthermore, a language phenomenon that exerts influence on a translation in the level of phrases, clauses, or sentences is referred to as a phrase-level language phenomenon.

Here is an example of “(24) Translation of the adnominal present tense” at page 196 of “Fujitsu ATLAS V12 User's Guide,” published in 2005. This document is hereinafter referred to as Non Patent Document 2. There has been proposed a system that preselects a translation method of adnominal clauses. This type of machine translation system includes adnominal clause translation method selection means, input means, translation means, and output means. The adnominal clause translation method selection means preselects a translation method of adnominal clauses before machine translation. The input means inputs a sentence in a first language. The translation means translates the inputted sentence into a second language based on the selection of the adnominal clause translation method selection means. The output means outputs the resultant translation result.

### DISCLOSURE OF INVENTION

### Problem(s) to be Solved by the Invention

The prior art has suffered from a problem that, when one sentence includes a plurality of adnominal clauses, different translation methods cannot be selected for the respective adnominal clauses.

The invention of Non Patent Document 1 cannot select a translation method for adnominal clauses. Furthermore, according to Non Patent Document 2, one translation method for adnominal clauses needs to be selected before a translation process. In other words, only one translation method can be selected for adnominal clauses in one translation process.

For example, it is assumed that a sentence [symbol] [symbol] [symbol] [symbol] (Japanese) is translated by the invention disclosed in Non Patent Document 2. It is also assumed that there are three translation methods selectable for adnominal clauses, which include “translation using a relative,” “translation using a to-infinitive,” and “translation using an -ing participle.” This sentence includes two adnominal clauses of [symbol] [symbol] and [symbol] If this sentence is to be translated into “The person standing there was looking for a book to read,” then “translation using an -ing participle” and “translation using a to-infinitive” should be selected for the adnominal clause [symbol] and the adnominal clause [symbol] respectively. However, the prior art 2 can select only one of “translation using an -ing participle” and “translation using a to-infinitive.”

This problem is not limited to adnominal clauses and also arises when a translation method is selected for other types of phrase-level language phenomena. Generally, when a sentence includes a plurality of phrase-level language phenomena of the same type, the method disclosed in Non Patent Document 2 cannot select different translation methods for those language phenomena.

The present invention has been made in view of these circumstances. It is an object of the present invention to provide machine translation technology capable of selecting different translation methods for a plurality of language phenomena of the same type included in an original sentence.

### Means to Solve the Problem(s)

In order to solve the above problem, the present invention provides the following character data processing method, computer program, and character data processing system.

Specifically, one aspect of the present invention provides a method of converting part or all of first character data of a phrase, a clause, or a sentence into another expression to generate second character data, characterized by comprising: a step of storing, in a storage device (storage device 3), an acceptance rule indicative of correspondence between a language phenomenon, a principal word of the language phenomenon, and a scope of the language phenomenon, and a conversion method as correspondence between a language phenomenon and another expression into which an expression of the language phenomenon is converted; a step of executing a process in a processing device (acceptance part calculation portion 22), the process including applying the acceptance rule stored in the storage device for a word W included in the first character data and extracting an acceptance part of one of the word W, a phrase, a clause, and a sentence including the word W; a step of executing a process in a processing device (translation method selection portion 23), the process including generating a converted expression of the acceptance part in accordance with the conversion method (translation method) stored in the storage device, the conversion method corresponding to a language phenomenon of the extracted acceptance part; and a step of executing a process in a processing device (second translation portion 24), the process including generating the second character data based on the converted expression and the first character data.

Furthermore, one aspect of the present invention provides a computer program for executing a procedure of converting part or all of first character data of a phrase, a clause, or a sentence into another expression to generate second character data, the procedure comprising: a process of storing, in a storage device (storage device 3), an acceptance rule indicative of correspondence between a language phenomenon, a principal word of the language phenomenon, and a scope of the language phenomenon, and a conversion method as correspondence between a language phenomenon and another expression into which an expression of the language phenomenon is converted; a process of applying the acceptance rule stored in the storage device for a word W included in the first character data and extracting an acceptance part of one of the word W, a phrase, a clause, and a sentence including the word W; a process of generating a converted expression of the acceptance part in accordance with the conversion method (translation method) stored in the storage device, the conversion method corresponding to a language phenomenon of the extracted acceptance part; and a process of generating the second character data based on the converted expression and the first character data.

Moreover, one aspect of the present invention provides a character data processing system (machine translation system 100) for converting part or all of first character data of a phrase, a clause, or a sentence into another expression to generate second character data, characterized by comprising: a storage device (storage device 3) for storing an acceptance rule indicative of correspondence between a language phenomenon, a principal word of the language phenomenon, and a scope of the language phenomenon, and a conversion method as correspondence between a language phenomenon and another expression into which an expression of the language phenomenon is converted; a processing device (acceptance part calculation portion 22) for applying the acceptance rule stored in the storage device for a word W included in the first character data and extracting an acceptance part of one of the word W, a phrase, a clause, and a sentence including the word W; a processing device (translation method selection portion 23) for generating a converted expression of the acceptance part in accordance with the conversion method (translation method) stored in the storage device, the conversion method corresponding to a language phenomenon of the extracted acceptance part; and a processing device (second translation portion 24) for generating the second character data based on the converted expression and the first character data.

### EFFECT(S) OF THE INVENTION

According to the present invention, a translation method for phrase-level language phenomena such as adnominal clauses or articles can be selected on the translation result by provision of a translation method selection portion.

Furthermore, according to the present invention, an acceptance part can be determined with reference to an acceptance rule so as to prevent a state in which a translation method cannot be selected for each language phenomenon in the translation result.

### BRIEF DESCRIPTION OF DRAWINGS

FIG. 1 is a block diagram showing a machine translation system 100 according to an embodiment of the present invention.

FIG. 2 is a flow chart explanatory of operation of a first translation portion 21 and an acceptance part calculation portion 22 in the machine translation system 100.

FIG. 3 is a flow chart explanatory of operation of a translation method selection portion 23 and a second translation portion 24 in the machine translation system 100.

FIG. 4 is a diagram showing the correspondence between equivalent terms, the part of speech of each word, and the positions of phrases, clauses, and headwords in Example 1.

FIG. 5 shows an example of a screen displayed to a user when the translation method selection processor 23 is to accept user's selection of translation methods.

FIG. 6 shows an example of the part of speech of each word and a dependency structure of a translation result in Example 2.

### BEST MODE FOR CARRYING OUT THE INVENTION

Next, there will be described a machine translation system 100 in the best mode for carrying out the invention. The machine translation system 100 is a system operable to mechanically translate an original sentence in a first language to generate a translation in a second language. Hereinafter, the first language may be referred to as the primary language, and the second language may be referred to as the secondary language.

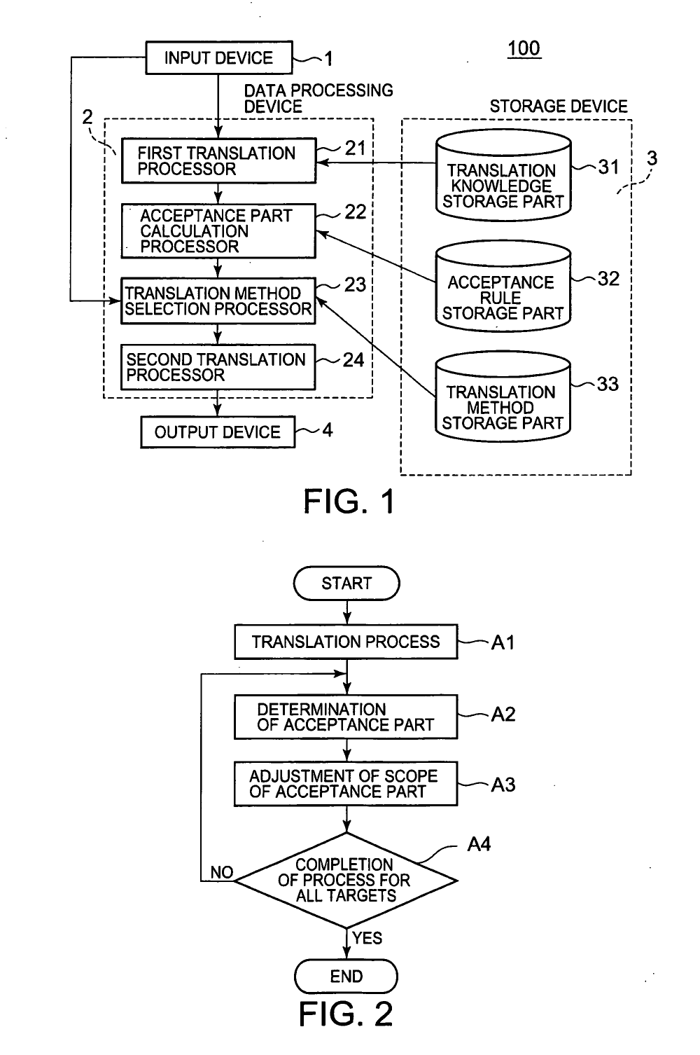

Referring to FIG. 1, the machine translation system 100 has an input device 1 such as a keyboard or a mouse, a data processing device 2 operable by program control, a storage device 3 operable to store information, and an output device 4 such as a display device or a printer.

The storage device 3 includes a translation knowledge storage part 31, an acceptance rule storage part 32, and a translation method storage part 33.

Translation knowledge for translation from the first language into the second language is prestored in the translation knowledge storage part 31. The translation knowledge includes a translation dictionary and translation rules.

Acceptance rules, which are used for reference when acceptance parts are extracted, are stored in the acceptance rule storage part 32. Here, the acceptance part refers to a part that is a possible target of retranslation and includes a predetermined language phenomenon in a translation result. The acceptance rules refer to rules for extracting an acceptance part. As described later, the machine translation system 100 performs retranslation on part or all of acceptance parts extracted from a translation result, based on a translation method corresponding to a language phenomenon included in those acceptance parts.

Translation methods selectable for each language phenomenon are stored in the translation method storage part 33.

The data processing device 2 includes a first translation processor 21, an acceptance part calculation processor 22, a translation method selection processor 23, and a second translation processor 24. Generally, those processors operate in the following manner.

The first translation processor 21 is operable to translate a sentence in the primary language that has been inputted from the input device 1 into the secondary language with use of the translation knowledge stored in the translation knowledge storage part 31.

The acceptance part calculation processor 22 is operable to calculate an acceptance part in a translation result according to the acceptance rules stored in the acceptance rule storage part 32. More specifically, the acceptance part calculation processor 22 is operable to determine whether or not each word in a translation result is a principal portion of an acceptance part in accordance with the acceptance rules, and also to determine the scope of an acceptance part for a word that is a principal portion of the acceptance part in accordance with the acceptance rules.

The translation method selection processor 23 is operable to accept user's selection of a translation method for a language phenomenon in a translation result according to information about the acceptance parts calculated by the acceptance part calculation processor 22 and information about the translation methods stored in the translation method storage part 33.

The second translation processor 24 is operable to modify the translation result in accordance with the translation method accepted by the translation method selection processor 23.

Next, an overall operation of the machine translation system 100 will be described. First, operation of calculating an acceptance part that accepts a translation method for each language phenomenon in the translation result will be described below with reference to FIG. 2.

First, the first translation processor 21 translates a sentence in the primary language that has been inputted from the input device 1 into the secondary language with use of the translation knowledge stored in the translation knowledge storage part 32 (Step A1).

Then, for each word in the translation result, the acceptance part calculation processor 22 refers to the acceptance rules relating to each language phenomenon and determines whether or not the word is a principal portion of an acceptance part that accepts selection of a translation method of the language phenomenon (Step A2).

Subsequently, the acceptance part calculation processor 22 adjusts the scope of the acceptance part for the language phenomenon with centering the word in accordance with the acceptance rules (Step A3).

Finally, if the determination as to an acceptance part has not been completed for all language phenomena in the translation result, the processes from Step A2 are performed for words for which the determination has not been completed. If the determination has been completed for all language phenomena, the process is terminated (Step A4).

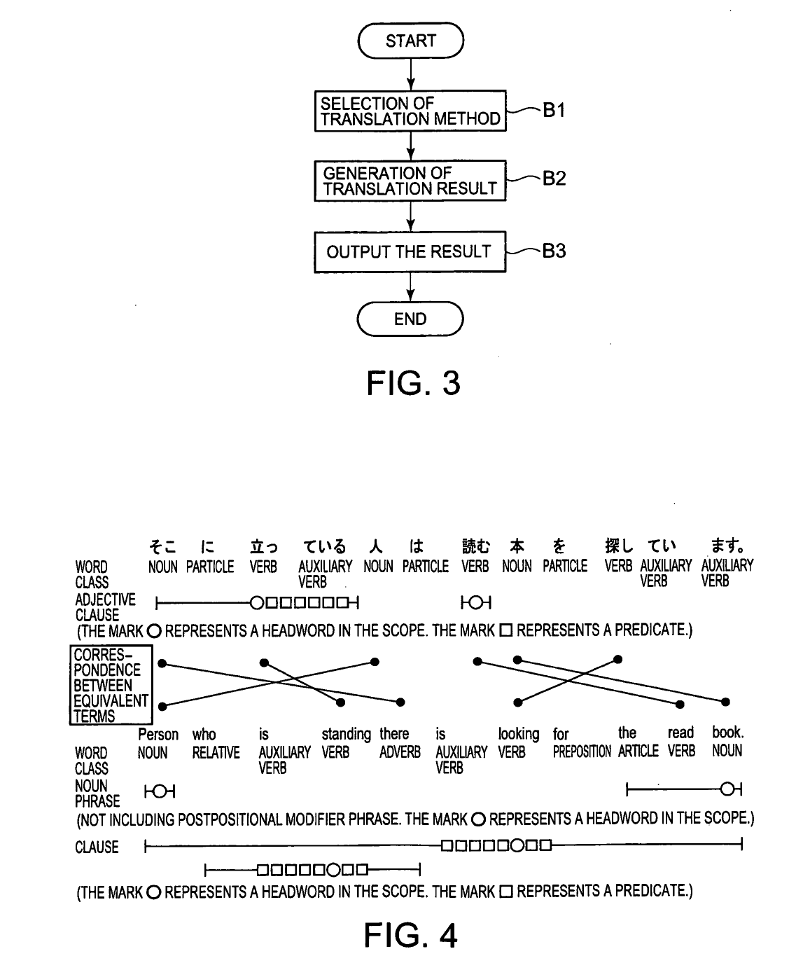

Next, operation of the machine translation system 100 when a user selects a translation method with use of information about the calculated acceptance part will be described with reference to FIG. 3.

First, the translation method selection processor 23 accepts user's selection of translation methods in accordance with the information about the calculated acceptance parts and the information about the translation methods that has been stored in the translation method storage part 33 (Step B1). That is, the user selects part or all of the calculated acceptance parts and selects a translation method for each of the selected acceptance parts.

Next, the second translation processor 24 modifies the translation result in accordance with the accepted translation methods (Step B2).

Finally, the output device 4 outputs the modified translation result (Step B3).

Other variations of the present embodiment will be described below.

For each word in the translation result, the acceptance part calculation processor 22 determines whether or not the word is a principal portion of an acceptance part. Nevertheless, such determination may be made on other units such as phrases, clauses, or sentences, rather than words.

Furthermore, the second translation processor may only adjust the translation result in accordance with the translation methods specified by the translation method selection processor 23, or may perform retranslation with reference to the specified translation method and in accordance with the translation knowledge stored in the translation knowledge storage part 32.

Next, advantages of the present embodiment will be described.

According to the present embodiment, selection of translation methods for phrase-level language phenomena such as adnominal clauses or articles can be accepted on the translation result by provision of the translation method selection processor 23.

Furthermore, according to the present embodiment, since the acceptance part calculation processor 22 refers to the acceptance rules stored in the acceptance rule storage part 33, an acceptance part can be determined so as to prevent a state in which a translation method cannot be accepted for a language phenomenon in the translation result.

### Example 1

The operation of the machine translation system 100 will be described with more specific examples. Example 1 describes a case of translation from Japanese to English in which language phenomena for which translation methods can be selected include phenomena relating to articles, phenomena relating to verbs, and phenomena relating to adnominal clauses.

A translation dictionary and translation rules used for machine translation are stored in the translation knowledge storage part 31. In this example, the translation dictionary includes dictionary data used for reference when machine translation from Japanese into English is performed. Similarly, the translation rules include data indicative of rules to be applied to an original Japanese sentence to generate an English translation when machine translation from Japanese into English is performed.

Acceptance rules for determining an acceptance part in a translation result that can accept translation methods of articles, translation methods of verbs, and translation methods of adnominal clauses have been stored in the acceptance rule storage part 32. Preferably, each acceptance rule includes (1) a determination rule for determining whether or not each word of a translation result is a principal word of an acceptance part that accepts selection of translation methods for that language phenomenon, and (2) a scope rule for determining the scope of an acceptance part with centering the word.

Translation methods selectable for each language phenomenon are stored in the translation method storage part 33. Table 1 shows an example of a list of translation methods selectable for each language phenomenon. Table 1 is shown merely by way of example. Types of language phenomena to be processed and translation methods selectable for each language phenomenon are not limited to the example of Table 1.

TABLE 1

| Type of Language | |
|---|---|
| Phenomena | List of Translation Methods |
| Articles | Definite article (“the”) |
| | Indefinite article (“a”) |
| | No article |
| Adnominal clauses | Use of relative |
| | To-infinitive |
| | -ing participle |
| Verbs | Active voice |
| | Passive voice |

Acceptance rules for calculating an acceptance part that accepts translation methods for each of language phenomena listed in Table 1 are as follows. The acceptance rules described herein include determination rules and scope rules.

For determining that the type of language phenomena is articles, the determination rule is defined such that a headword of a noun phrase including no postpositional modifier phrase is set as a target word. The scope rule is defined such that respective words in the noun phrase including the headword but no postpositional modifier phrase and an article directly depending upon that noun phrase are set as an acceptance part. As a variation of the scope rule, words included in one or both of the noun phrase and the article may be set as an acceptance part.

In the case where the type of language phenomena is verbs, the determination rule is defined such that, if the part of speech of a headword in a predicate in each clause is a verb, the headword is set as a target word. The scope rule is defined such that a portion of the predicate in which verbs and auxiliary verbs, including the headword, continue is set as an acceptance part.

In the case where the type of language phenomena is adnominal clauses, the determination rule is defined such that an equivalent term in the translation result that corresponds to a headword of a predicate in a main clause of an adnominal clause of an input sentence is set as a target word. The scope rule is defined such that words included in a portion of the predicate including the equivalent term in which verbs, adjectives, and auxiliary verbs, including the equivalent term, continue, and a relative if there is any relative clause corresponding to the adnominal clause are set as an acceptance part. As a variation of the scope rule, words included in one or both of the continuing portion and the relative may be set as an acceptance part.

The headword refers to a principal word of a phrase or a clause. Definition of the headword differs depending upon a language analysis method used for machine translation. In any language analysis method, however, one word in a phrase or a clause becomes a headword of the phrase or the clause.

The postpositional modifier phrase to a noun phrase refers to a preposition phrase, a relative clause, an adjective phrase, or a verb phrase having a headword of a present participle or a past participle that modifies the noun phrase from behind the noun phrase.

Now, it is assumed that the input sentence is [symbol] [symbol] [symbol] [symbol] (Japanese), that the translation result first outputted by the system is “Person who is standing there is looking for the read book,” and that the target translation result is “The person standing there is looking for a book to read.”

First, there will primarily be described operation of the acceptance part calculation processor 22 when the acceptance part calculation processor 22 calculates an acceptance part of the translation result that accepts selection of translation methods for each language phenomenon in the translation result.

When the input sentence [symbol] [symbol] [symbol] [symbol] is inputted, the first translation processor 21 uses the translation knowledge stored in the translation knowledge storage part 32 to generate the translation result “Person who is standing there is looking for the read book.”

FIG. 4 shows the correspondence between words of the input sentence and equivalent terms of the translation result, the part of speech of each word in the input sentence and the translation result, the scope of each adnominal clause and its predicate and the headword of the predicate in the input sentence, the scope and the headword of a noun phrase including no postpositional modifier phrase in the translation result, and the scope of each phrase and its predicate and the headword of the predicate in the translation result according to the present example. Some part of FIG. 4 will be described below. The part of speech of the word [symbol] in the input sentence is a “noun,” and the corresponding equivalent term is “there.” The input sentence has two adnominal clauses including [symbol] and [symbol] The predicates of those adnominal clauses are [symbol] and [symbol] respectively. The headwords of those predicates are [symbol] and [symbol] respectively. The part of speech of the word “Person” in the translation result is a “noun.” The translation result has two noun phrases including “Person” and “the read book.” The headwords of those noun phrases are “Person” and “book,” respectively. The translation result has two clauses including the entire sentence of the translation result and “who is standing there.” The predicates of those clauses are “is looking” and “is standing,” respectively. The headwords of those predicates are “looking” and “standing,” respectively.

Next, the acceptance part calculation processor 22 refers to the acceptance rules in the acceptance rule storage part 32 for each word of the translation result, determines whether or not the word is a principal word of an acceptance part that accepts selection of translation methods for the language phenomenon in the translation result, and then adjusts the scope of the acceptance part. Table 2 shows the results in which the process has been completed for all of the words. In Table 2, the “ID” denotes an identifier assigned to each language phenomenon in the translation result, the “Type” denotes the type of the language phenomenon, the “Scope” denotes an acceptance part in the translation result that can accept selection of translation methods for the language phenomenon, and the number preceding each word in the scope denotes the assigned order from the first word of the translation result.

TABLE 2

| ID | Type | Scope |
|---|---|---|
| 1 | Article | 1 (Person) |
| 2 | Adnominal | 2 (who), 3 (is), 4 (standing), 5 (there) |
| | clause | |
| 3 | Verb | 3 (is), 4 (standing) |
| 4 | Verb | 6 (is), 7 (looking) |
| 5 | Article | 9 (the), 10 (read), 11 (book) |
| 6 | Adnominal | 10 (read) |
| | clause | |
| 7 | Verb | 10 (read) |

For example, the word “book” at the end of the translation result is now considered. Referring to FIG. 4, “book” is the headword of a noun phrase including no postpositional modifier phrase. Therefore, “book” meets the aforementioned determination rule of the acceptance rules for articles. Then, referring to the scope rule of the acceptance rules for articles, all words of the noun phrase “the read book,” which includes “book” but no postpositional modifier phrase, are set as a target. Therefore, the same ID 5 is assigned to “the,” “read,” and “book,” and the type is set to be an “article” (see ID 5 of Table 2). Furthermore, the word [symbol] in the original sentence, which corresponds to the word “book” from which the assigned ID 5 is originated, is also linked to ID 5.

Furthermore, the word “standing” is considered, for example. Referring to FIG. 4, “standing” is the headword of a predicate in a clause. Therefore, “standing” meets the determination rule of the acceptance rules for verbs. Then, referring to the scope rule of the acceptance rules for verbs, all words of the scope (“is standing”) in which verbs and auxiliary verbs, including the equivalent term, continue within the predicate (“is standing”) including “standing” are set as a target. Therefore, the same ID 3 is newly assigned to “is” and “standing,” and the type is set to be a “verb” (see ID 3 of Table 2). Furthermore, the word [symbol] in the original sentence, which corresponds to the word “standing” from which the assigned ID 3 is originated, is also linked to ID 3.

Meanwhile, the word [symbol] in the input sentence, which corresponds to “standing,” is the headword of a predicate in a main clause of the adnominal clause [symbol] in the input sentence. Therefore, the word “standing” also meets the determination rule of the acceptance rules for adnominal clauses. Then, referring to the scope rule of the acceptance rules for adnominal clauses, all words of the scope (“is standing”) in which verbs, adjectives, and auxiliary verbs, including the equivalent term, continue within the predicate (“is standing”) including “standing,” and the relative (“who”) in the relative clause (“who is standing”), which corresponds to the adnominal clause [symbol] , are set as a target. Therefore, the same ID 2 is newly assigned to “who,” “is,” and “standing,” and the type is set to be an “adnominal clause” (see ID 2 of Table 2). Furthermore, the word [symbol] in the original sentence, which corresponds to the word “standing” from which the assigned ID 2 is originated, is also linked to ID 2.

For example, the words “who,” “is,” “there,” and the like do not meet the determination rule of the acceptance rules for any language phenomenon. Therefore, calculation originating from those words is not made for any acceptance part.

Second, there will be described user's operation to select a translation method with use of information about the calculated acceptance parts in the present example.

Acceptance parts shown in Table 2 have been calculated by the calculation process for acceptance parts. A user can select, via the input device, a translation method for part of the translation result displayed on the output device 4. As a preferred method of selection via the input device, the translation result (first character data recited in claims) outputted by the first translation processor 21 is displayed on the image display device. The user moves a mouse pointer with a pointing device such as a mouse and right-clicks in a state in which the mouse pointer is positioned on one word of the displayed translation result. In response to this operation, a language phenomenon corresponding to an acceptance part including the one word is selected. The corresponding words are highlighted, and a list of translation methods selectable for that language phenomenon is displayed. Seeing this list, the user selects a translation method from the list with the mouse or the like. Thus, a translation method of that language phenomenon is selected.

A method of selection via the input device is not limited to the aforementioned preferred selection method. A word to be selected may be specified by other methods using an input device, such as positioning a cursor for text input or selecting the word by ranging. A list of translation methods may be displayed by other methods using an input device, such as selection from a tool bar or selection from menu items of a window. Furthermore, a translation method may be accepted even if a blank between words is selected.

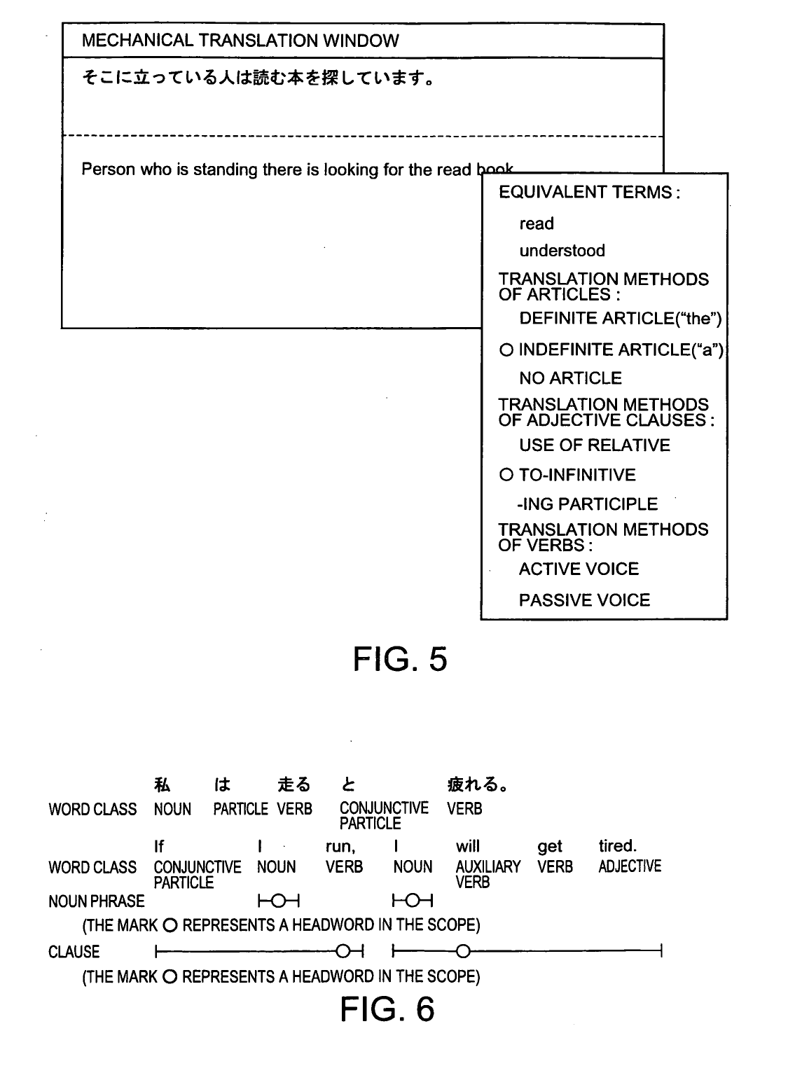

FIG. 5 shows an example in which a list of translation methods selectable for a specified language phenomenon is displayed. In this example, when a user positions a mouse pointer on “read” and right-clicks, the list of translation methods selectable for the language phenomenon including “read” is displayed.

As can be seen from Table 2, translation methods of articles (ID 5 of Table 2), translation methods of verbs (ID 6 of Table 2), translation methods of adnominal clauses (ID 7 of Table 2) can be accepted for “read.” If translation methods for a plurality of language phenomena can be accepted, all of the translation methods are preferably displayed in the list.

If there is any unacceptable translation method for some reason, not all of acceptable translation methods may be displayed. If there are no acceptable translation methods, a list window itself may not be displayed, or no items relating to translation methods may be displayed in the list.

Furthermore, as shown in FIG. 5, the displayed list may include a translation method other than phrase-level translation methods, e.g., translation into alternative words. In FIG. 5, “understood” is displayed as an equivalent term for [symbol] in addition to “read.”

Furthermore, each mark “o” in FIG. 5 represents a translation method sought to select by the user. Thus, a plurality of translation methods may be selected for one word.

Here, it is assumed that an attempt is made to bring the translation result first outputted by the system (“Person who is standing there is looking for the read book.”) close to the target translation result (“The person standing there is looking for a book to read.”) by selection of translation methods.

First, the user considers addition of the definite article (“the”) to the first word (“person”) of the translation. When the user positions the mouse pointer on “person” and right-clicks, the translation method selection processor 23 retrieves a list of translation methods selectable for “person” and outputs the retrieval result to the output device 4.

Referring to Table 2, translation methods of articles (ID 1) can be selected for “person.” Therefore, the translation method selection processor 23 outputs a list of translation methods relating to articles (“Definite article (‘the’),” “Indefinite article (‘a’),” and “No article”) to the output device 4. When the user then selects “Definite article (‘the’)” from the list, the second translation processor reflects this selection on the translation result, thereby generating a translation result of “The person who is standing there is looking for the read book.” The system outputs the generated translation result from the output device.

Thereafter, the translation result is modified by selecting translation methods for other parts in the same manner as described above. First, when a translation method of translating adnominal clauses with an “-ing participle” is selected on “who is standing” in the translation result, the translation is modified into “The person standing there is looking for the read book.”

Subsequently, when a translation method of translating articles with the “indefinite article (‘a’)” is selected on “the read book,” the translation result is modified into “The person standing there is looking for a read book.”

Finally, when a translation method of translating adnominal clauses with a “to-infinitive” is selected on “read,” the translation result is modified into “The person standing there is looking for a book to read.” Thus, the target translation result can be obtained.

Advantages of the present invention according to the first example will be described below.

First, when one sentence includes a plurality of language phenomena of the same type (adnominal clauses in the present example) as seen in the illustrative sentence of the present example, Prior Art 2 cannot select an independent translation method for each of the language phenomena. According to the present example, however, a translation method can be selected on the translation result independently for each of the language phenomena by provision of the translation method selection processor 23.

Second, as to selection of the definite article (“the”) for “person” in the present example, mere combination of Prior Arts 1 and 2 cannot generate the definite article (“the”) by selection on the translation result because an original translation result includes no word to be specified for generating “the.” According to the present example, the acceptance part calculation processor 22 can set the word “person” as a word to be specified for generating “the.” Thus, the definite article (“the”) can be generated by selection on the translation result.

In the present example, translation from Japanese into English has been described. However, the present invention may be applied to a translation system for translation between other languages.

Furthermore, as to timing of reflection of the modified translation result on the output device, it is preferable to modify the translation result and reflect the modified translation result on the output device each time one translation method is selected. However, it is possible to modify the translation result and reflect the modified translation result on the output device only when the user instructs retranslation by a retranslation button or the like after all of necessary translation methods are selected.

Furthermore, according to the present example, a list of translation methods selectable for a word for which a translation method is to be selected is displayed. However, the display of the list may be skipped by a keyboard shortcut or the like. Specifically, it is possible to define a keyboard shortcut key corresponding to each translation method and press a keyboard shortcut key corresponding to a translation method to be selected when a cursor for text input is positioned on a word for which the translation method is to be selected.

### Example 2

In Example 1, the acceptance rules are applied to each word of the first translation outputted by the first translation portion 21 to determine an acceptance part (the acceptance part calculation portion 22). Translation methods corresponding to a language phenomenon in an acceptance part are provided to the user (the translation method selection portion 23). The first translation is modified in accordance with a translation method selected by the user, thereby generating a second translation (the second translation portion 24).

In contrast to Example 1, further modification is made to the second translation in Example 2. In Example 1, for such further modification, the second translation is inputted to the acceptance part calculation portion 22, and the aforementioned processes are repeated. At that time, it is preferable for possible translation methods to include a modification for recovering the first translation.

However, the first translation cannot be recovered from the second translation if a word that was present in the first translation is eliminated in the second translation during the process of generating the second translation from the first translation, particularly if the eliminated word is a word of an acceptance part for translation methods according to the acceptance rules.

For example, it is assumed that a translation method of articles is selected. It is assumed that there are three translation methods selectable for articles (“Definite article (‘the’),” “Indefinite article (‘a’),” and “No article”). If a portion of the translation result for which a translation method for articles is to be selected originally includes either the definite article or the indefinite article, the article can be used as an acceptance part of translation methods, and a translation method for articles can thus be selected. However, if the portion of the translation result originally includes no articles, there are no articles that can be used for acceptance of translation methods. Accordingly, a translation method cannot be selected for articles.

This problem may arise when a translation method is selected for other types of phrase-level language phenomena. For example, in the aforementioned selection of a translation method for adnominal clauses, if the original translation does not include a relative such as “who,” “which,” or “where,” then a relative cannot be used as an acceptance part for selection of a translation method.

As another example, selection of translation methods (including two methods of “translation using a conjunctive particle” and “translation using a participial construction”) for temporal conjunctive particles (such as “when” and “if”) is assumed. If the original translation result has a participial construction, there are no conjunctive particles that can be used as an acceptance part for the translation methods. Therefore, a conjunctive particle cannot be used for acceptance for selection of a translation method.

In the present embodiment, when a word in an acceptance part for selection of translation methods according to the acceptance rules is eliminated in the translation result during generation of the second translation from the first translation if at least one translation method for the language phenomenon to which the acceptance rules are applied is selected, then one or both of a headword of the shortest phrase among noun phrases or declinable phrases including the word and all independent words included in the phrase are set as an acceptance part.

Thus, the first translation can be recovered from the second translation via the headword or the independent word as an acceptance part.

Example 2 of the present invention will be described in detail below. In Example 2, the machine translation system 100 shown in FIG. 1 operates differently than in Example 1.

The contents of the translation knowledge storage part 31 are the same as in Example 1.

Acceptance rules for calculating an acceptance part that accepts translation methods for conjunctive particles are stored in the acceptance rule storage part 32. The acceptance rules include the following first half and second half. The first half includes a determination rule that is defined such that a conjunctive particle is set as a target word and a scope rule that is defined such that that word is set as an acceptance scope. The second half is defined such that, if the word is eliminated in a translation result when at least one translation method for conjunctive particles is selected, then the headword of the shortest phrase among noun phrases or declinable phrases including the word is also set as an acceptance part for selection of translation methods. All of independent words included in the shortest phrase may be used as a portion to be added as an acceptance part in the case of elimination. Language phenomena to be processed or a list of translation methods selectable for each language phenomenon is not limited to the list shown in Table 1.

The correspondence between the types of language phenomena and translation methods selectable for those language phenomena as shown in Table 3 are stored in the translation method storage part 33. This correspondence may be stored in the translation method storage part 33 together with the correspondence shown in Table 1 and the correspondence between other types of language phenomena and selectable translation methods.

TABLE 3

| Type of Language Phenomena | List of Translation Methods |
|---|---|
| Conjunctive particle | Translation using a conjunctive particle |
| | Translation using a participial |
| | construction |

Next, the present example will be described with a specific example of the original sentence and the translation thereof. Now, it is assumed that the original sentence, i.e., the input sentence is [symbol] (Japanese) and that the first translation result first outputted by the system is “If I run, I will get tired.”

First, there will be described operation of calculating an acceptance part in the translation result that accepts selection of translation methods for each language phenomenon in the translation result.

When the input sentence [symbol] is inputted, the first translation processor 21 uses the translation knowledge stored in the translation knowledge storage part 32 to generate a translation result “If I run, I will get tired.” FIG. 6 shows the part of speech of each word in the input sentence and the translation result and the dependency structure of the translation result. Referring to FIG. 6, for example, the part of speech of the word “If” in the translation result is a “conjunctive particle,” and only the declinable phrase “If I run” is a phrase including “If” in the translation result. The headword of this phrase is “run.”

Next, the acceptance part calculation processor 22 refers the acceptance rules in the acceptance rule storage part 32 for each word of the translation result, determines whether or not that word is a principal word of an acceptance part that accepts selection of translation methods for the language phenomenon in the translation result, and then adjusts the scope of the acceptance part. Table 4 shows the results in which the process has been completed for all of the words. Items in Table 4 are shown in the same manner as the items in Table 3 of the first example. As shown in FIGS. 4 and 6, an acceptance part corresponding to one language phenomenon is not required to be continuous in sequence. For example, an acceptance part of translation methods for the language phenomenon of ID 1 in FIG. 4 (conjunctive particle [symbol] is formed of “If” and “run.” Thus, the acceptance part is not continuous in the translation shown in FIG. 6.

TABLE 4

| ID | Type | Scope |
|---|---|---|
| 1 | Conjunctive particle | 1 (If), 3 (run) |

Procedures of calculating an acceptance part are the same as in the first example, and the determination rule and the scope rule of the acceptance rules are applied in turn to each word of the translation result. Considering the word “If” in the translation result, “If” is a conjunctive particle as shown in FIG. 6. Thus, the word “If” meets the determination rule of the acceptance rules for conjunctive particles.

Next, referring to the first half of the scope rule of the acceptance rules for conjunctive particles, “If” is set as an acceptance scope. Therefore, ID 1 is assigned to “If,” and the type is set to be a “conjunctive particle.” Furthermore, the word [symbol] in the original sentence, which corresponds to the word “If” from which the assigned ID 1 is originated, is also linked to ID 1.

It is now assumed that “participial construction” is selected as a translation method of conjunctive particles for “If.” The translation result becomes “Running, I will get tired.” Thus, “If” is eliminated from the translation result. Specifically, since the conditions of the second half of the scope rule of the acceptance rules for conjunctive particles are met, the same ID 1 is assigned to the headword (“run”) of the shortest phrase (“If I run”) among noun phrases or declinable phrases including “If.” As a result, information about the acceptance part shown in Table 4 is obtained.

Second, there will be described user's operation to select a translation method with use of information about the calculated acceptance parts.

Operation of selecting a translation method is the same as in the first example.

Here, if the user selects a translation method of translating a conjunctive particle with “participial construction” on “If” in the translation result, then the translation result becomes “Running, I will get tired.” It is assumed that the user seeks to recover the original translation result by putting the conjunctive particle “If” at a position at which “If” was present just before that time.

In the first example, translation methods can be selected only for “If” for which the equivalent term directly changes. Therefore, the original translation result (“If I run, I will get tired.”) cannot be recovered by selection of a translation method on the current translation result (“Running, I will get tired.”). According to the present example, the original translation result can be recovered by selecting a translation method of translating a conjunctive particle with “using conjunctive particle” on “Running.”

Advantages of the present invention according to the second example will be described below.

Mere combination of Prior Arts 1 and 2 may be unable to select a translation method if an acceptance part for selection of translation methods is eliminated by selection of a translation method as seen in the illustrative sentence of the present example. According to the present example, the acceptance rule storage part 33 has acceptance rules having features in that, if a word included in an acceptance part for selection of translation methods according to the acceptance rules is eliminated from the translation result when at least one translation method is selected for a language phenomenon to which the acceptance rules are applied, a parent word of that word in a dependency structure of the translation result is also set as an acceptance part for selection of translation methods. Accordingly, the acceptance part calculation processor 22 sets the word “run” as an acceptance part for selection of translation methods for conjunctive particles. Thus, an acceptance part for selection of translation methods can always be present in the translation result. Therefore, it is possible to prevent a state in which a translation method cannot be selected.

While the present invention has been described with the embodiments and examples, the present invention is not limited to those embodiments and examples. As a matter of course, various modifications can be made therein within the scope of the technical concept of the present invention.

For example, according to one aspect of the present invention, the aforementioned character data processing method may further include a step of associating a word X (“run” in Example 2) other than the word W, in the phrase, the clause, or the sentence of the first character data including the word W, with the word W if the converted expression does not include the word W (“If” in Example 2); and a step of converting the phrase, the clause, or the sentence of the second character data including the word X into a phrase, a clause, or a sentence including the word W based on the association between the word X and the word W to generate third character data. With this configuration, even if the word W is eliminated during the process of generating the second translation from the first translation, an expression including the word W can be recovered by tracing the association between the word W and the word X. This holds true in the other aspects of the present invention.

For example, those character data processing methods are applicable to a case of modification of a translation result obtained by machine translation. This holds true in the other aspects of the present invention.

This application is based upon Japanese Patent Application No. 2007-081916, filed on Mar. 27, 2007, the disclosure of which is incorporated herein by reference in its entirety.

1-9. (canceled)

10. A method of converting part or all of first character data of a phrase, a clause, or a sentence into another expression to generate second character data, comprising:
a step of storing, in a storage device, an acceptance rule for each language phenomenon not limited to a specific word and a conversion method as correspondence between a language phenomenon and another expression into which an expression of the language phenomenon is converted, the acceptance rule including a determination rule for determining a principal word of the language phenomenon and a scope rule for determining a scope of an acceptance part including the principal word;
a step of executing a process in a processing device, the process including applying the acceptance rule stored in the storage device for a word W included in the first character data and extracting an acceptance part of one of the word W, a phrase, a clause, and a sentence including the word W;
a step of executing a process in a processing device, the process including generating a converted expression of the acceptance part in accordance with the conversion method stored in the storage device, the conversion method corresponding to a language phenomenon of the extracted acceptance part; and
a step of executing a process in a processing device, the process including generating the second character data based on the converted expression and the first character data.

11. The character data processing method as recited in claim 10, comprising:
a step of associating a word X other than the word W, in the phrase, the clause, or the sentence of the first character data including the word W, with the word W if the converted expression does not include the word W; and
a step of converting the phrase, the clause, or the sentence of the second character data including the word X into a phrase, a clause, or a sentence including the word W based on the association between the word X and the word W to generate third character data.

12. A method of modifying a translation result obtained by machine translation, by applying the character data processing method as recited in claim 10 to the translation result.

13. A computer program for executing a procedure of converting part or all of first character data of a phrase, a clause, or a sentence into another expression to generate second character data, the procedure comprising:
a process of storing, in a storage device, an acceptance rule for each language phenomenon not limited to a specific word and a conversion method as correspondence between a language phenomenon and another expression into which an expression of the language phenomenon is converted, the acceptance rule including a determination rule for determining a principal word of the language phenomenon and a scope rule for determining a scope of an acceptance part including the principal word;
a process of applying the acceptance rule stored in the storage device for a word W included in the first character data and extracting an acceptance part of one of the word W, a phrase, a clause, and a sentence including the word W;
a process of generating a converted expression of the acceptance part in accordance with the conversion method stored in the storage device, the conversion method corresponding to a language phenomenon of the extracted acceptance part; and
a process of generating the second character data based on the converted expression and the first character data.

14. The computer program as recited in claim 13, wherein the procedure includes:
a process of associating a word X other than the word W, in the phrase, the clause, or the sentence of the first character data including the word W, with the word W if the converted expression does not include the word W; and
a process of converting the phrase, the clause, or the sentence of the second character data including the word X into a phrase, a clause, or a sentence including the word W based on the association between the word X and the word W to generate third character data.

15. A computer program for executing machine translation with a computer, wherein the processes recited in claim 13 are applied to a translation result obtained by machine translation.

16. A character data processing system for converting part or all of first character data of a phrase, a clause, or a sentence into another expression to generate second character data, comprising:
a storage device for storing an acceptance rule for each language phenomenon not limited to a specific word and a conversion method as correspondence between a language phenomenon and another expression into which an expression of the language phenomenon is converted, the acceptance rule including a determination rule for determining a principal word of the language phenomenon and a scope rule for determining a scope of an acceptance part including the principal word;
a processing device for applying the acceptance rule stored in the storage device for a word W included in the first character data and extracting an acceptance part of one of the word W, a phrase, a clause, and a sentence including the word W;
a processing device for generating a converted expression of the acceptance part in accordance with the conversion method stored in the storage device, the conversion method corresponding to a language phenomenon of the extracted acceptance part; and
a processing device for generating the second character data based on the converted expression and the first character data.

17. The character data processing system as recited in claim 16, further comprising:
associating a word X other than the word W, in the phrase, the clause, or the sentence of the first character data including the word W, with the word W if the converted expression does not include the word W, and
converting the phrase, the clause, or the sentence of the second character data including the word X into a phrase, a clause, or a sentence including the word W based on the association between the word X and the word W to generate third character data.

18. A machine translation system comprising the character data processing system as recited in claim 16 for application to the translation result.
